(19) United States
(12) Patent Application Publication
(10) Pub. No.: US 2019/0391679 A1
(43) Pub. Date: Dec. 26, 2019

(54) METAL MESH TOUCH ELECTRODE FOR TOUCH PANEL

(71) Applicants: Interface Technology (ChengDu) Co., Ltd., Chengdu (CN); Interface Optoelectronics (Shenzhen) Co., Ltd., Shenzhen (CN); General Interface Solution Limited, Miaoli County (TW)

(72) Inventors: Hsuan-Man CHANG, Miaoli County (TW); Po-Lin CHEN, Miaoli County (TW); Ya-Yin CHENG, Miaoli County (TW); Chia-Chi YEH, Miaoli County (TW)

(21) Appl. No.: 16/039,604

(22) Filed: Jul. 19, 2018

(30) Foreign Application Priority Data
Jun. 21, 2018 (CN) 201810643808.X

(51) Int. Cl. G06F 3/041

(52) U.S. Cl. CPC G06F 3/041; G06F 2203/04112

(57) ABSTRACT

A metal mesh touch electrode for a touch panel comprises a plurality of breakpoint regions, a plurality of first metal mesh electrodes and a plurality of second metal mesh electrodes. The breakpoint regions are disposed between the first and second metal mesh electrodes. The first metal mesh electrodes comprises a first metal mesh layout formed by a plurality of first metal lines and a plurality of second metal lines that mutually intersect. The second metal mesh electrodes include a second metal mesh layout formed by the plurality of first metal lines and the plurality of second metal lines that mutually intersect. The plurality of first metal lines and the plurality of second metal lines intersect to form a plurality of intersections creating a mesh spacing. Widths of the first and second metal mesh electrodes and the breakpoint region comprise a sensing spacing.

### CROSS-REFERENCE TO RELATED PATENT APPLICATION

This non-provisional application claims priority to and the benefit of, pursuant to 35 U.S.C. § 119(a), patent application Serial No. CN201810643808.X filed in China on Jun. 21, 2018. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a metal mesh touch electrode, and more particularly to a metal mesh touch electrode utilized in a touch panel.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In order to intuitively operate the electronic device, the touch control technology is widely applied to the electronic device. Thus, users can perform various operations on the electronic devices by the touch panel.

In order to get better visual effect, the touch panels generally use transparent conductor as a touch electrode, for example Indium Tin Oxide (ITO). Since the ITO has some disadvantages such as high cost, poor transparency, high impedance and poor flexibility, etc. Therefore, the ITO is not suitable for using in the large size touch panel.

Comparing to ITO, the metal meshes have some advantages such as low cost, high transparency, low impedance and high flexibility, such that the metal meshes are generally used to replace with the ITO in larger touch panels.

During manufacturing process of the metal electrode, the metal mesh is completely covered on a substrate, and then a part of metal wires of the metal mesh are cut, that are break points, to form a independent electrode. However, the manufacturing process may result different layouts for each electrode on the metal mesh. When the layout of the each electrodes is different, the density of each electrode is different, which may cause some problems such as the difference in transparency, impedance, flexibility, and poor electrical properties of each electrode. Therefore, these problems may cause the touch sensing accuracy of the touch control electronic device not good.

### SUMMARY

It is an object of the present invention to provide a metal mesh touch electrode for a touch panel, wherein the metal mesh touch electrode is capable of providing individual independent electrodes with a uniform metal mesh layout so as to achieve superior electrical characteristics.

In order to achieve the above and other objectives, the present invention provides a metal mesh touch electrode for a touch panel, comprising a plurality of breakpoint regions, a plurality of first metal mesh electrodes and a plurality of second metal mesh electrodes. The plurality of first metal mesh electrodes is disposed on one side of the breakpoint regions, and comprises a first metal mesh layout formed by a plurality of first metal lines and a plurality of second metal lines that mutually intersect. The plurality of second metal mesh electrodes is disposed on the other side of the breakpoint regions, and comprises a second metal mesh layout formed by the plurality of first metal lines and the plurality of second metal lines that mutually intersect; wherein, the first metal mesh layout is identical to the second metal mesh layout.

### BRIEF DESCRIPTION OF THE DRAWINGS

FIG. 1 is a drawing illustrating a metal mesh touch electrode for a touch panel according to an embodiment of the present invention;

FIG. 2 is a drawing illustrating a metal mesh touch electrode for a touch panel according to an embodiment of the present invention; and,

FIG. 3 is a drawing illustrating a metal mesh touch electrode for a touch panel according to an embodiment of the present invention.

### DETAILED DESCRIPTION

To achieve the above objectives and effectiveness as well as the technical means and structures adopted by the present invention, for better understanding, features and functions of the present invention are given in embodiments with the accompanying drawings below.

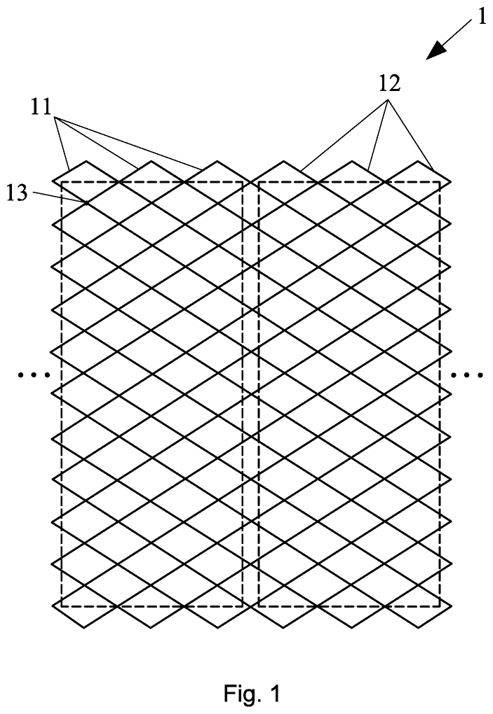

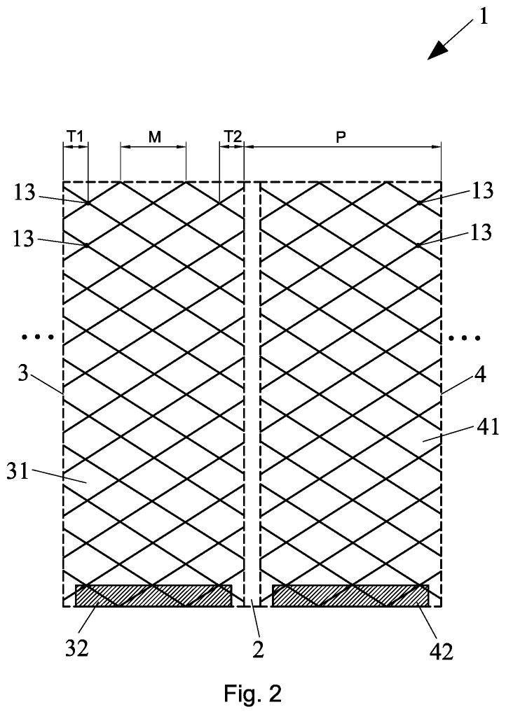

Refer to FIGS. 1 and 2 which illustrate a metal mesh touch electrode for a touch panel according to an embodiment of the present invention. The term “touch panel” refers to a touch sensitive display device that users can interact with the display screen by fingers, for example operating I/O instruction, or selecting options of a menu, etc. The term “metal mesh” refers to touch electrodes for touch panels, that may be manufactured by printed electronic circuit technologies or etching technologies.

FIG. 1 illustrates that a metal mesh touch electrode 1 is patterned on a substrate. The structure in FIG. 2 illustrates that a metal mesh touch electrode 1 that is cut into a first metal mesh electrode 3 and a second metal mesh electrode 4 and forms a breakpoint region 2. The touch electrode 1 includes a plurality of breakpoint regions 2, a plurality of first metal mesh electrodes 3 and a plurality of second metal mesh electrodes 4.

The breakpoint regions 2 are configured between the first metal mesh electrodes 3 and the second metal mesh electrodes 4. The breakpoint region 2 makes the first metal mesh electrode 3 and the second metal mesh electrode 4 be electrically independent of each other.

The first metal mesh electrode 3 is disposed on one side of the breakpoint region 2, and comprises a first metal mesh layout 31 formed by a plurality of first metal lines 11 and a plurality of second metal lines 12 that mutually intersect. In one embodiment, the line widths of the plurality of first metal lines 11 and the plurality of second metal lines 12 both are 3 □m. The first metal mesh electrode 3 further comprises a first connecting area 32 disposed on one side of the first metal mesh electrode 3 to transmit a touch control signal.

The second metal mesh electrode 4 is disposed on the other side of the breakpoint region 2, and comprises a second metal mesh layout 41 formed by the plurality of first metal lines 11 and the plurality of second metal lines 12 that mutually intersect. Similarly, the line widths of the plurality of first metal lines 11 and the plurality of second metal lines 12 are both 3 ␣m. The second metal mesh electrode 4 further comprises a second connecting area 42 disposed on one side of the second metal mesh electrode 4 to transmit a touch control signal.

Each of the plurality of first metal lines 11 extends in a first direction and in parallel. Each of the plurality of second metal lines 12 extends in a second direction and in parallel. Furthermore, the plurality of first metal lines 11 and the plurality of second metal lines 12 mutually intersect to form the first metal mesh electrode 3 and the second metal mesh electrode 4.

The first metal mesh layout 31 is identical to the second metal mesh layout 41. This means the position, the density and the quantity of the plurality of first metal lines 11 and the plurality of second metal lines 12 are completely that same with those of the second metal mesh layout 41. Thus, each of metal mesh electrodes has stable electrical characteristics such as uniform transparency, impedance, and flexibility.

Details of the present invention in operation are illustrated on the basis of the above structure, composition and design. Refer to FIG. 2 which illustrates a metal mesh touch electrode for a touch panel according to an embodiment of the present invention. The plurality of first metal lines 11 and the plurality of second metal lines 12 mutually intersect to form a plurality of intersections 13. A mesh distance M is between the two intersections 13 of the metal mesh electrode in the horizontal direction. A sensing distance P is the width of the second metal mesh electrode 4 (or a width of the first metal mesh electrode 3) adding with a width of the breakpoint region 2 in the horizontal direction. The sensing distance P is an integer multiple of the mesh distance M. In one embodiment, the integer is between 2 and 20, such as 2, 3, 4, 5, 6, 7, 8, 9, 10 or 20, but not limited therein.

In an embodiment, a first distance T1 is between one side of the first metal mesh electrode 3 and the intersection 13 adjacent to the side. A second distance T2 is between the other side and the intersection 13 adjacent to the side. The first distance T1 is equal to the second distance T2. The structure of the second metal mesh electrode 4 is the same with first metal mesh electrode 3.

The left half and the right half of the first metal mesh electrode 3 (or the second metal mesh electrode 4) are the same and symmetrical. Because the left half and right half of the each of the metal mesh electrode (the first metal mesh electrode 3 or the second metal mesh electrode 4) are symmetrical, thus each of the metal mesh electrodes has uniform impedance, transmittance, and the like).

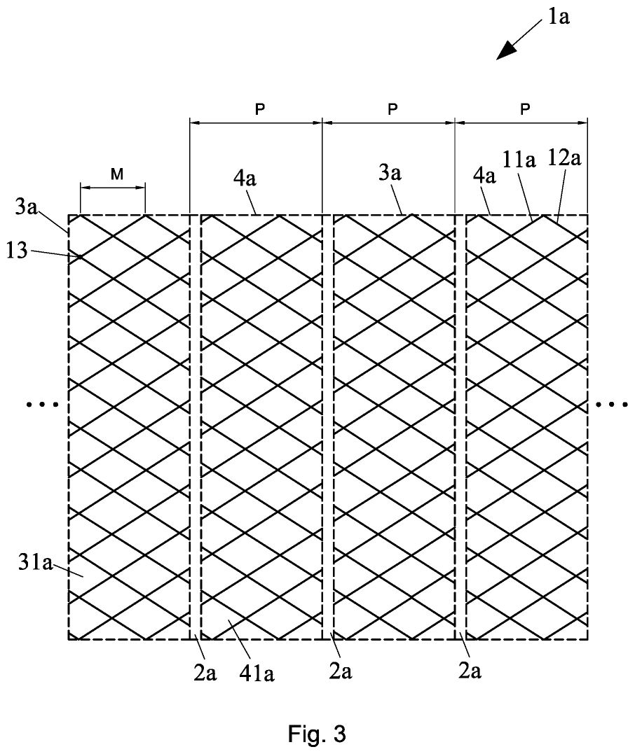

FIG. 3 illustrates a metal mesh touch electrode for a touch panel according to an embodiment of the present invention. In another embodiment of the present invention, a metal mesh touch electrode la comprises a plurality of first metal mesh electrodes 3a, a plurality of second metal mesh electrodes 4a, and a plurality of breakpoint regions 2a. The plurality of first metal mesh electrodes 3a and the plurality of second metal mesh electrodes 4a are arranged as mutually intersecting. The plurality of breakpoint regions 2a are between the first metal mesh electrodes 3a and the second metal mesh electrodes 4a, such that the first metal mesh electrodes 3a and the second metal mesh electrodes 4a are electrically independent of each other.

The first metal mesh electrodes 3a comprise a first metal mesh layout 31a formed by a plurality of first metal lines 11a and a plurality of second metal lines 12a that mutually intersect, and the second metal mesh electrodes 4a comprise a second metal mesh layout 41a formed by the plurality of first metal lines 11a and the plurality of second metal lines 12a that mutually intersect.

The plurality of first metal lines 11a and the plurality of second metal lines 12a mutually intersect to form a plurality of intersections 13a. A mesh distance M is between the two intersections 13a of the metal mesh electrode in the horizontal direction. A sensing spacing P is the width of the second metal mesh electrode 4a (or first metal mesh electrode 3a) adding with the width of the breakpoint region 2a in the horizontal direction. The sensing distance P is an integer multiple of the mesh distance M. The mesh layout plans of the first metal mesh layouts 31a and the second metal mesh layouts 41a are the same. However, the left and right halves of the individual metal mesh layouts (the first metal mesh layout 31a or the second metal mesh layout 41a) are asymmetrical mesh structures.

Thus, the present invention provides a metal mesh touch electrode with individual independent electrodes that have the same metal mesh layout, and thereby achieve superior electrical characteristics.

While the present invention has been described by way of example and in terms of the preferred embodiments, it is to be understood that the present invention is not limited thereto. Any simple modifications and equivalent changes of structures made on the basis of the disclosure and drawings of the present invention are to be similarly encompassed within the scope of the present invention.

What is claimed is:

1. A metal mesh touch electrode for a touch panel, comprising:
a plurality of breakpoint regions;
a plurality of first metal mesh electrodes disposed on one side of the breakpoint regions, comprising a first metal mesh layout formed by a plurality of first metal lines and a plurality of second metal lines that mutually intersect; and
a plurality of second metal mesh electrodes disposed on another side of the breakpoint regions, comprising a second metal mesh layout formed by the plurality of first metal lines and the plurality of second metal lines that mutually intersect; wherein, the first metal mesh layout is identical to the second metal mesh layout.

2. The metal mesh touch electrode for a touch panel according to claim 1, wherein first metal mesh electrode and the second metal mesh electrode are electrically independent from each other by the breakpoint region.

3. The metal mesh touch electrode for a touch panel according to claim 1, wherein each of the plurality of first metal lines extends in a first direction and is arranged in parallel each other, and each of the plurality of second metal lines extends in a second direction, and is arranged in parallel each other.

4. The metal mesh touch electrode for a touch panel according to claim 1, wherein the first metal mesh electrode further comprises a first connecting area disposed on one side of the first metal mesh electrode and configured to transmit a touch control signal.

5. The metal mesh touch electrode for a touch panel according to claim 1, wherein the second metal mesh electrode further comprises a second connecting area disposed on one side of the second metal mesh electrode and configured to transmit a touch control signal.

6. The metal mesh touch electrode for a touch panel according to claim 1, wherein line widths of the plurality of first metal lines and the plurality of second metal lines both are 3 □m.

7. The metal mesh touch electrode for a touch panel according to claim 1, wherein the plurality of first metal lines and the plurality of second metal lines mutually intersect to form a plurality of intersections; the two adjacent intersections in the horizontal direction have a mesh distance; a width of the second metal mesh electrode and a width of the breakpoint region or a width of the first metal mesh electrode and the width of the breakpoint region in the horizontal direction is a sensing distance; wherein the sensing distance is an integer multiple of the mesh distance.

8. The metal mesh touch electrode for a touch panel according to claim 7, wherein the integer is between 2 and 20.

9. The metal mesh touch electrode for a touch panel according to claim 1, wherein the plurality of first metal lines and the plurality of second metal lines mutually intersect to form a plurality of intersections; between one side of the first metal mesh electrode and the plurality of intersections near the side is a first distance; between the other side and the plurality of intersections near said other side is a second distance; wherein the first distance is equal to the second distance.

10. The metal mesh touch electrode for a touch panel according to claim 1, wherein the plurality of first metal lines and the plurality of second metal lines mutually intersect to form a plurality of intersections; between one side of the second metal mesh electrode and the plurality of intersections near the side is a first distance; between the other side and the plurality of intersections near said other side is a second distance; wherein the first distance is equal to the second distance.
